(19) United States
(12) Patent Application Publication
(10) Pub. No.: US 2009/0138822 A1
(43) Pub. Date: May 28, 2009

(54) METHOD OF FLEXIBLY BLOCKING OUT BUSY-TIME IN CALENDARS

(75) Inventors: John M. Lance, Littleton, MA (US); Amy D. Travis, Arlington, MA (US)

Correspondence Address: CANTOR COLBURN LLP - IBM BOCA RATON, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/946,112

(22) Filed: Nov. 28, 2007

(51) Int. Cl. G06F 3/048

(52) U.S. Cl. 715/810

(57) ABSTRACT

An application for use with a computer to allow a user to manage blocks of time. The application includes a graphical user interface (GUI) to be initiated upon a first command of the user with respect to a first icon, which represents a period of time in accordance with a time resolution, or one or more of a set of second icons, which represent units of time that are each smaller than and within the period of time represented by the first icon. The GUI includes a title field, a duration field, and a plurality of qualifier fields. A controller updates the calendar of the user based on information inputted into the GUI upon a second command of the user with respect to the GUI, and a time manager manages the time block.

### BACKGROUND OF THE INVENTION

1. Field of the Invention

Aspects of the present invention relate to a calendar application and, more particularly, to a calendar application for use with a computer to allow a user to manage blocks of time.

2. Description of the Background

In most conventional calendar applications, users may need to use the calendar applications to block out time to do their work in order to, for example, prevent meetings from being scheduled during certain work times. However, conventional calendar applications tend to be inflexible to this end. The applications generally require users to pick particular blocks of time for the work times and prevent all meetings from being scheduled during those blocks of time even if that particular time was chosen fairly arbitrarily and the users would willingly substitute those blocks of time for others.

For example, it is assumed that a user wants to make sure that one hour is free each day for doing research but the user does not care when that hour occurs (and might even be content with that time being split into two thirty-minute chunks). In order to ensure this block of time is available using conventional calendar applications, the user would have to block out a specific period of time, and then manage any adjustments to that time manually, by accepting meeting requests during that time, and moving that time to another portion of the day, or skipping it, depending on how their schedule worked out.

Moreover, other people will see this time block marked as busy time and/or will be notified when they try to schedule into it. This can cause trouble when trying to schedule a meeting with multiple people in that this manually entered time block may be the only time that all the people could meet, but it looks unavailable to certain people because it will have already been added explicitly to the calendar.

### SUMMARY OF THE INVENTION

In accordance with an aspect of the invention, an application for use with a computer to allow a user to manage blocks of time is provided and comprises a graphical user interface (GUI) to be initiated upon a first command of the user with respect to a first icon displayed by the computer in a calendar application, which represents a period of time in accordance with a time resolution of the calendar application, or one or more of a set of second icons displayed by the computer in the calendar application, which represent units of time that are each smaller than and within the period of time represented by the first icon. The GUI includes a title field in which the user specifies a title for a time block occurring within the time represented by the first icon or the one or more of the set of second icons, a duration field in which the user specifies an amount of time the time block is to last from an unspecified and variable start time to an unspecified and variable end time within the represented time and in accordance with the time resolution and a presence of a previously scheduled item in a calendar of the user, and a plurality of qualifier fields in which the user specifies any of a set of qualifiers relating to the time block. A controller updates the calendar of the user based on information inputted into the GUI upon a second command of the user with respect to the GUI, and a time manager manages the time block so as to insure that a subsequently organized item is not in an interfering condition.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### BRIEF DESCRIPTIONS OF THE DRAWINGS

The subject matter which is regarded as the invention is particularly pointed out and distinctly claimed in the claims at the conclusion of the specification. The foregoing and other aspects, features, and advantages of the invention are apparent from the following detailed description taken in conjunction with the accompanying drawings in which:

FIG. 1 shows an application according to an exemplary embodiment of the present invention; and

1FIG. 2 shows a graphical user interface according to an exemplary embodiment of the present invention.

### DETAILED DESCRIPTION OF THE INVENTION

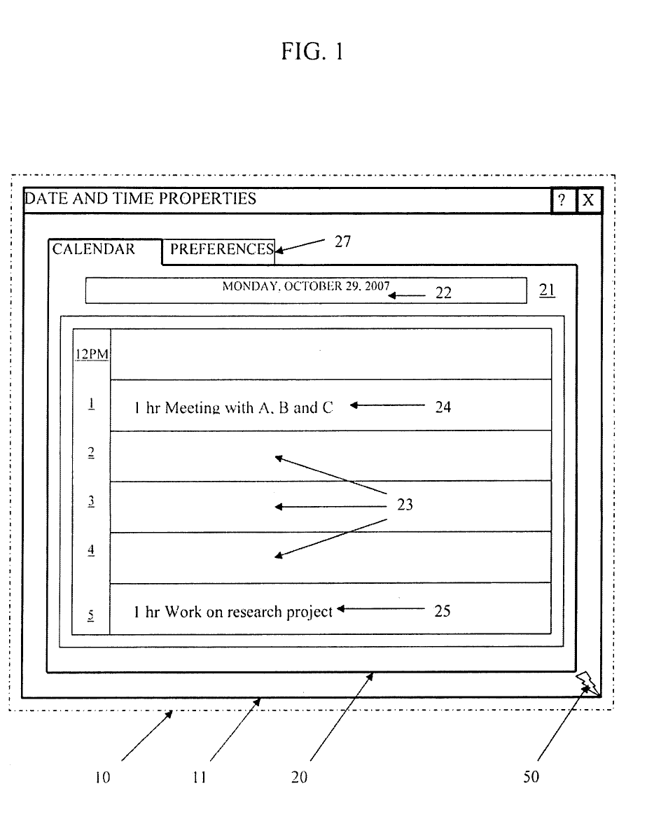

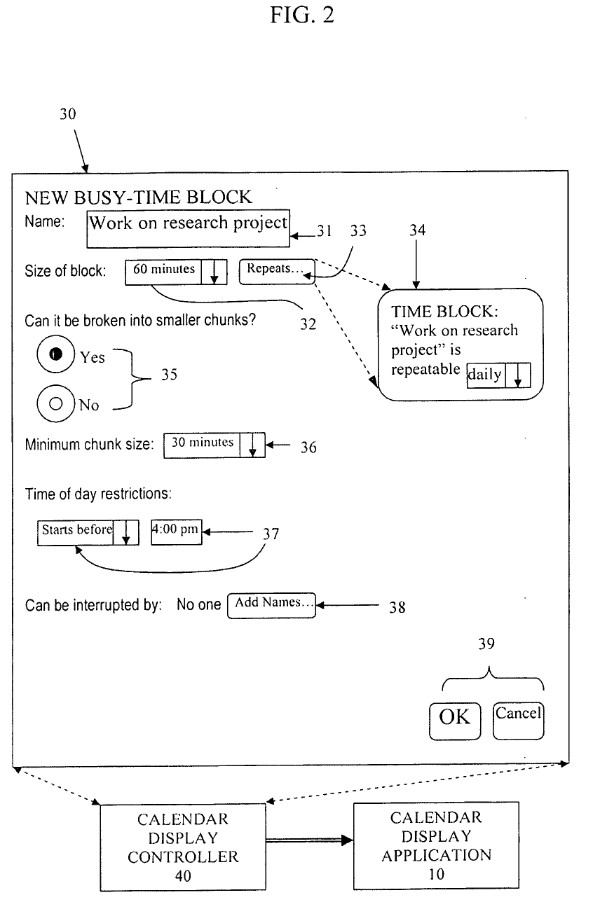

With reference to FIGS. 1 and 2, an application 10, in accordance with an embodiment of the invention, may be stored in a computer and accessed by a user of the computer to manage blocks of time. In particular, the application 10 may be employed to create a time block that blocks out time as requested by the user without the need for the user specifying precisely when the time block is to occur. In this respect, the application 10 is displayed via a window 11 and comprises a calendar display 20, a graphical user interface (GUI) 30, a calendar display controller 40 and a time manager 50.

The calendar display 20 provides for a display of a calendar 21 of the user that relates to a period of time in accordance with a time resolution, which may be yearly, monthly, weekly or daily. As shown in the exemplary calendar display 20 of FIG. 1, the time resolution is daily and, as such, the calendar display 20 displays a first icon 22, which, in this case, is the date of the displayed day. The calendar display 20 further includes a set of second icons 23, each of which represents units of time within the period of time that are smaller than the period of time and the time resolution. That is, where the time resolution is daily and the first icon 22 represents the date of the displayed day, each of the second icons 23 may represent hours of the displayed day. In similar fashion, where the time resolution is monthly, the first icon 22 represents a name of the displayed month and each of the set of the second icons 23 may represent days of the displayed month. Previously scheduled items 24, such as previously scheduled meetings, are provided within the appropriate icons of the set of second icons 23.

Here, it is noted that although the calendar display 20 of FIG. 1 is presented in column format, other formats are possible. For example, where the time resolution is monthly, the calendar display 20 may be presented as a typical calendar. Further, in another embodiment of the invention where the time resolution is daily, each of the set of second icons 23 may represent half hour units of time. Similarly, where the time resolution is monthly, each of the set of second icons 23 may represent weekly units of time with each month.

With reference to FIG. 2, upon a first command of the user via an interaction with respect to the first icon 22 or one or more of the set of second icons 23, a graphical user interface (GUI) 30 is initiated. Here, it is understood that such a command may be transmitted via a mouse used by the user to double click or to highlight and then right-click the first icon 22 or one or more of the set of second icons 23 (hereinafter referred to as “activated icons”).

As shown in FIG. 2, the GUI includes a title field 31 in which the user may specify a title for a time block occurring within the time represented by the activated icons (hereinafter referred to as “represented time”).

A duration field 32 allows the user to specify an amount of time the time block is to last from an unspecified and variable start time to an unspecified and variable end time within the represented time and in accordance with the time resolution and a presence of a previously scheduled item in a calendar of the user. In other words, the user is not required to indicate when the time block is to start and when the time block is to end.

As an example, if the time resolution is daily, the previously scheduled item 24 may be a meeting scheduled to last for 1 hour. Here, if the represented time is two hours long (i.e., the activated icons represent two hours of the displayed day), then the amount of time offered by the duration field 32 is limited to 1 hour or less and, while the user may specify any time block duration within that hour, the user is not required to specify exactly when that time block is to occur.

In addition, the GUI 30 further includes a plurality of qualifier fields in which the user specifics any of a set of qualifiers relating to the time block. These qualifiers may, in accordance with embodiments of the invention optionally include, but are not limited to, a repeat button 33, a dividing field 35, a chunk duration field 36, a restriction field 37 and an interrupter field 38.

The repeat button 33 is activated once the user specifies the amount of time the time block is to last and, once actuated by the user, activates a pop-up window 34, which allows the user to specify that the time block is repeatable. The dividing field 35 allows the user to specify that the time block is divisible into chunks of time. The chunk duration field 36 allows the user to specify a minimum amount of time the chunks of time are divisible into in accordance with the amount of time the time block is to last. Here, the chunk duration field 36 is activated when the user specifies that the time block is divisible into the chunks of time. The restriction field 37 allows the user to specify when the time block is restricted from occurring. The interrupter field 38 allows the user to specify individuals who are authorized to interrupt the time block.

A calendar display controller 40, which operates in the background of the application 10 according to well known computer algorithms, updates the calendar 21 of the user based on information inputted into the GUI 30 and closes the GUI 30 upon a second command of the user with respect to the GUI. Here, it is understood that the second command may be issued by the user by clicking on the “OK” button in the command field 39 of the GUI 30. Here, it is further understood that a click of the “CANCEL” button closes the GUI 30 without an update of the calendar 21.

Once updated, the calendar display 20 will include a third icon 25 that represents the time block that is generated by the user in the GUI 30. In an embodiment of the invention, the third icon 25 will show the length of the time block and the title as recorded in the GUI 30. In a further embodiment of the invention, the time block can be edited by a third command of the user via an interaction of the user with respect to the third icon 25. Such an interaction will re-activate the GUI 30, which will display the information inputted into the GUI 30 previously for the corresponding time block.

A time manager 50, which, like the calendar display controller 40, operates in the background of the application 10 according to well known computer algorithms, manages the time block so as to insure that a subsequently organized item is not in an interfering condition. A subsequently organized item is in an interfering condition where the time manager recognizes that the calendar 21 of the user is already filled by a previously scheduled item(s) 24 and/or a time block(s) 25 or that the potential time of the subsequently organized item conflicts with the previously scheduled item(s) 24 or the time block(s) 25.

Where the time manager 50 determines that the time block is in the interfering condition, in an embodiment of the invention, the time manager 50 may move the time block in accordance with the presence of the previously scheduled item, and/or override the time block by authorized individuals. In addition, the time manager 50 may act as a schedule monitor which prevents the subsequently organized item from being scheduled in the interfering condition. In another embodiment of the invention, the time manager 50 may generate a message which notifies the user (via e.g., email, internet messaging (IM) and/or private messaging PM) that the subsequently organized item is in the interfering condition. Furthermore, when scheduling of the subsequently organized item is attempted, if no available time remains for the desired day, then the person attempting the scheduling will see that the desired time for the item as being busy or filled (unless they are in the exception list as defined for time blocks scheduled within the desired day). Otherwise, if the block can fit in at another time during the day, the person scheduling the entry would see that time as available.

The time manager 50 operates in accordance with default settings and/or user defined preferences. The default settings and preferences screen can be accessed via the “preferences” tab 27. According to an embodiment of the invention, when accessing the default settings and preferences screen, the user can, among other actions, set the time of a general business day (i.e., from 8 am-6 pm) during which time blocks and meetings can be scheduled, set the time resolution and instruct the time manager 50 to act as the message generator or the schedule monitor.

While the disclosure has been described with reference to exemplary embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular exemplary embodiment disclosed as the best mode contemplated for carrying out this disclosure, but that the disclosure will include all embodiments falling within the scope of the appended claims.

1. A method of operating an application for use with a computer to allow a user to manage blocks of time therewith, the method comprising:
initiating a graphical user interface (GUI) upon a first command of the user with respect to a first icon displayed by the computer in a calendar application, which represents a period of time in accordance with a time resolution of the calendar application, or one or more of a set of second icons displayed by the computer in the calendar application, which represent units of time that are each smaller than and within the period of time represented by the first icon, the initiating of the GUI including:
displaying a title field in which the user specifies a title for a time block occurring within the time represented by the first icon or the one or more of the set of second icons,
displaying a duration field in which the user specifies an amount of time the time block is to last from an unspecified and variable staff time to an unspecified and variable end time within the represented time and in accordance with the time resolution and a presence of a previously scheduled item in a calendar of the user, and
displaying a repeat button that activates a pop-up window which allows the user to specify that the time block is repeatable, the repeat button being activated once the user specifies the amount of time the time block is to last, a dividing field that allows the user to specify that the time block is divisible into chunks of time, a chunk duration field that allows the user to specify a minimum amount of time the chunks of time are divisible into, the chunk duration field being activated when the user specifies that the time block is divisible into the chunks of time, a restriction field that allows the user to specify time when the time block is restricted from occurring, and an interrupter field that allows the user to specify individuals who are authorized to interrupt the time block;
updating the calendar of the user based on information inputted Into the GUI upon a second command of the user with respect to the GUI; and
managing the time block in accordance with default settings and/or user defined preferences and monitoring the calendar of the user to determine whether the subsequently organized item is in the interfering condition, and at least one of moving the time block in accordance with the presence of the previously scheduled item, overriding the time block by authorized individuals, generating a message which notifies the user that the subsequently organized item is in the interfering condition, and monitoring a schedule of the user to prevent the subsequently organized item from being scheduled in the interfering condition wherein;
if the time resolution is monthly, the method further comprises displaying each month separately and sequentially with the first icon representing the displayed month and each of the set of second icons correspondingly representing days of the displayed month, and
if the time resolution is daily, the calendar application displays each day of a week separately and sequentially with the first icon representing the displayed day and each of the set of second icons correspondingly representing hours of the displayed day.

2-4. (canceled)
